(19) United States
(12) Patent Application Publication
(10) Pub. No.: US 2005/0155397 A1
(43) Pub. Date: Jul. 21, 2005

(54) Woven strap lock structure

(76) Inventor: Chun-Te Yu, Fu-Hsing Hsiang (TW)

Correspondence Address: BRUCE H. TROXELL, 5205 LEESBURG PIKE, SUITE 1404, FALLS CHURCH, VA, 22041, US

(21) Appl. No.: 10/792,875

(22) Filed: Mar. 5, 2004

(30) Foreign Application Priority Data
Jan. 19, 2004 (TW) 93201051

(51) Int. Cl. E05B 73/00; E05B 37/02

(52) U.S. Cl. 70/58; 70/284; 70/285

(57) ABSTRACT

A woven strap lock structure including a male fastener and a female fastener. One end of the male fastener has an insertion tongue formed with a latch hook edge. The female fastener is composed of a seat body and a teeterboard type latch plate pivotally connected with the seat body. A key-unlocked unit is disposed in a non-insertion end of the seat body for controlling a push button. The other end of the seat body is formed with an insertion opening corresponding to the insertion tongue. The seat body is formed with an operation room communicating with the insertion opening, in which the latch plate is mounted. A numeral unlocking unit is disposed on the latch plate. One end of the latch plate is formed with an engaging edge corresponding to the latch hook edge of the insertion tongue for latching with the latch hook edge. The other end of the latch plate is a press end which can be pressed into the seat body to make the end of the latch plate with the engaging edge turned upward. The push button is disposed at the press end and controlled by the numeral unlocking unit. In a natural state, one end of the push button is resiliently engaged on a support section of the support member. When the numeral unlocking unit is unlocked or the key-unlocked unit is operated by a key, the support section releases the push button, permitting the latch plate to be pressed and unlatched.

### BACKGROUND OF THE INVENTION

The present invention is related to an improved woven strap lock structure, and more particularly to a woven strap lock structure with double locking effect.

The conventional locking apparatuses include numeral system and key-driven system. The numeral system includes numeral wheel type and press key type. These locking apparatuses are widely applied to various fields. For example, Taiwanese-Patent No. 369068, entitled “hanging lock structure” and Taiwanese Patent No. 498918, entitled “hanging lock structure (5)” disclose locks pertaining to key-driven system. Taiwanese Patent No. 32470, entitled “numeral lock of baggage case or suitcase” and Taiwanese Patent No. 46563, entitled “adjustable numeral lock of suitcase” disclose locks pertaining to numeral system.

Practically, after the baggage case or suitcase is locked and transferred to a destination, it often takes place that a user misses the key or forgets to bring the key or forgets the unlocking number and cannot open the baggage case or suitcase. Under such circumstance, it is necessary to ask a locksmith to unlock or even break the lock for opening the baggage case or suitcase.

In another condition, it is known that when checked by U.S. customs workers, in case it is found the customs workers that the contents of the baggage case or suitcase are suspicious, the customs workers are authorized by U.S. government to forcedly break off the lock of the baggage case or suitcase and open the same for checking the contents. The damaged lock will be a loss of a user and will lead to trouble and inconvenience to the user, especially during travel.

In order to improve the above situation, U.S. government and customs regulate that the lock manufacturers must provide a standard key for the customs for opening all the locks manufactured by the manufacturers. According to this regulation, there are several lock manufacturers all over the world who are allowed to manufacture such locks.

It is therefore tried by the applicant to provide a locking apparatus which meets the regulation of U.S. government and customs. In case a user forgets to bring the unlocking tool or forgets the unlocking number, the locking apparatus provides another unlocking measure for the user.

### SUMMARY OF THE INVENTION

It is therefore a primary object of the present invention to provide an improved woven strap lock structure which has double locking effect.

According to the above object, the woven strap lock structure of the present invention includes a male fastener and a female fastener. One end of the male fastener has an insertion tongue formed with a latch hook edge. The female fastener is composed of a seat body and a teeterboard type latch plate pivotally connected with the seat body. A key-unlocked unit is disposed in a non-insertion end of the seat body for controlling a push button. The other end of the seat body is formed with an insertion opening corresponding to the insertion tongue. The seat body is formed with an operation room communicating with the insertion opening, in which the latch plate is mounted. A numeral unlocking unit is disposed on the latch plate. One end of the latch plate is formed with an engaging edge corresponding to the latch hook edge of the insertion tongue for latching with the latch hook edge. The other end of the latch plate is a press end which can be pressed into the seat body to make the end of the latch plate with the engaging edge turned upward. The push button is disposed at the press end and controlled by the numeral unlocking unit. In a natural state, one end of the push button is resiliently engaged on a support section of the support member. When the numeral unlocking unit is unlocked or the key-unlocked unit is operated by a key, the support section releases the push button, permitting the latch plate to be pressed and unlatched.

The present invention can be best understood through the following description and accompanying drawings wherein:

### BRIEF DESCRIPTION OF THE DRAWINGS

FIG. 1 is a perspective assembled view of a preferred embodiment of the present invention;

FIG. 2 is a perspective view of the present invention, showing that the male fastener is unlatched from the female fastener;

FIG. 3 is a perspective exploded view of the female fastener of the present invention;

FIG. 4 is a perspective partially explode view of the female fastener according to FIG. 3;

FIG. 5 is a sectional view showing that the numeral unlocking unit of the present invention is in a locked state with the male and female fasteners latched with each other;

FIG. 6 is a sectional view showing that the numeral unlocking unit of the present invention is in an unlocked state with the male and female fasteners unlatched from each other;

FIG. 7 is a sectional view showing that the key-unlocked unit of the present invention is in a locked state with the male and female fasteners latched with each other;

FIG. 8 is a sectional view showing that the key-unlocked unit of the present invention is in an unlocked state with the male and female fasteners unlatched from each other;

FIG. 9 is a perspective exploded view of another embodiment of the present invention, showing another type of key-unlocked unit;

FIG. 10 is a perspective exploded view according to FIG. 9, in which the key-unlocked unit is in a locked state;

FIG. 11 is a perspective exploded view according to FIG. 9, in which the key-unlocked unit is in an unlocked state; and

FIG. 12 is a perspective view showing that the key-unlocked unit of the present invention is mounted at one end of the latch plate with the engaging edge.

### DETAILED DESCRIPTION OF THE PREFERRED EMBODIMENTS

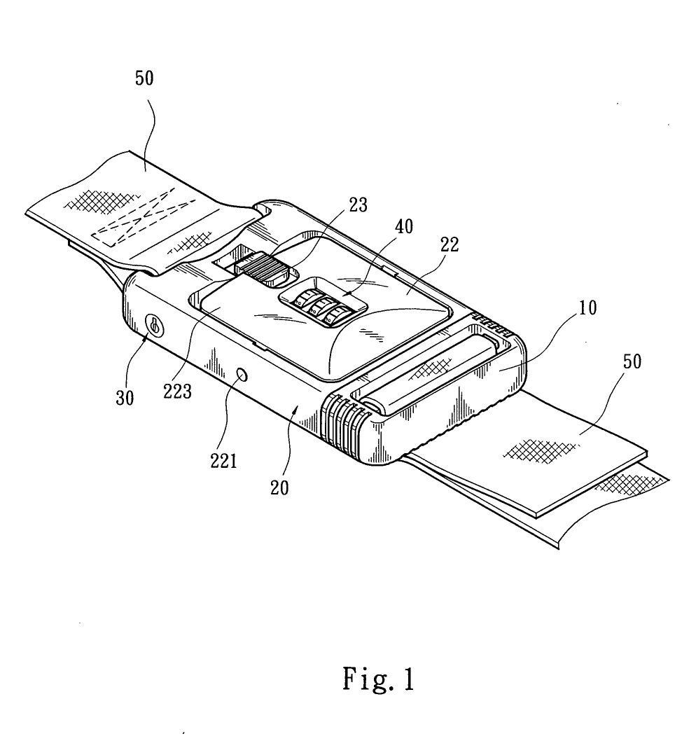

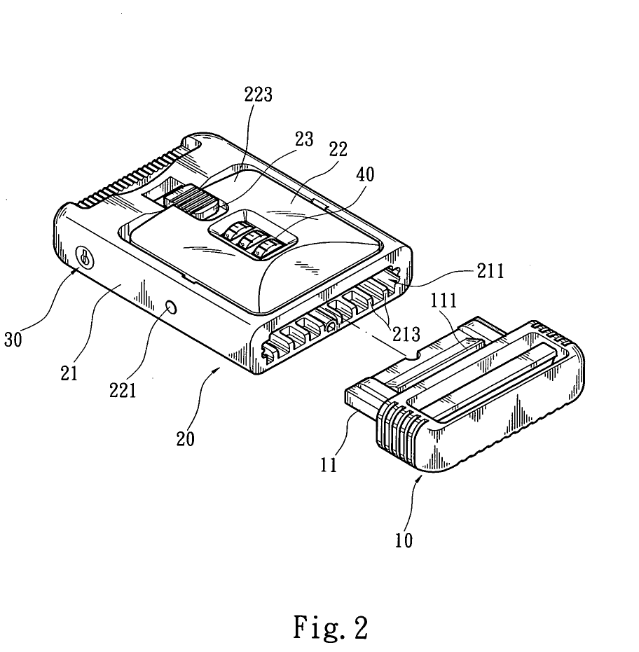

Please refer to FIGS. 1 and 2. The woven strap lock structure of the present invention is composed of a male fastener 10 and a female fastener 20. One end of the male fastener 10 is looped by a fastening strap 50. The other end of the male fastener 10 has an insertion tongue 11 which can be inserted into the female fastener 20. A front end of the insertion tongue 11 is formed with a latch hook edge 111.

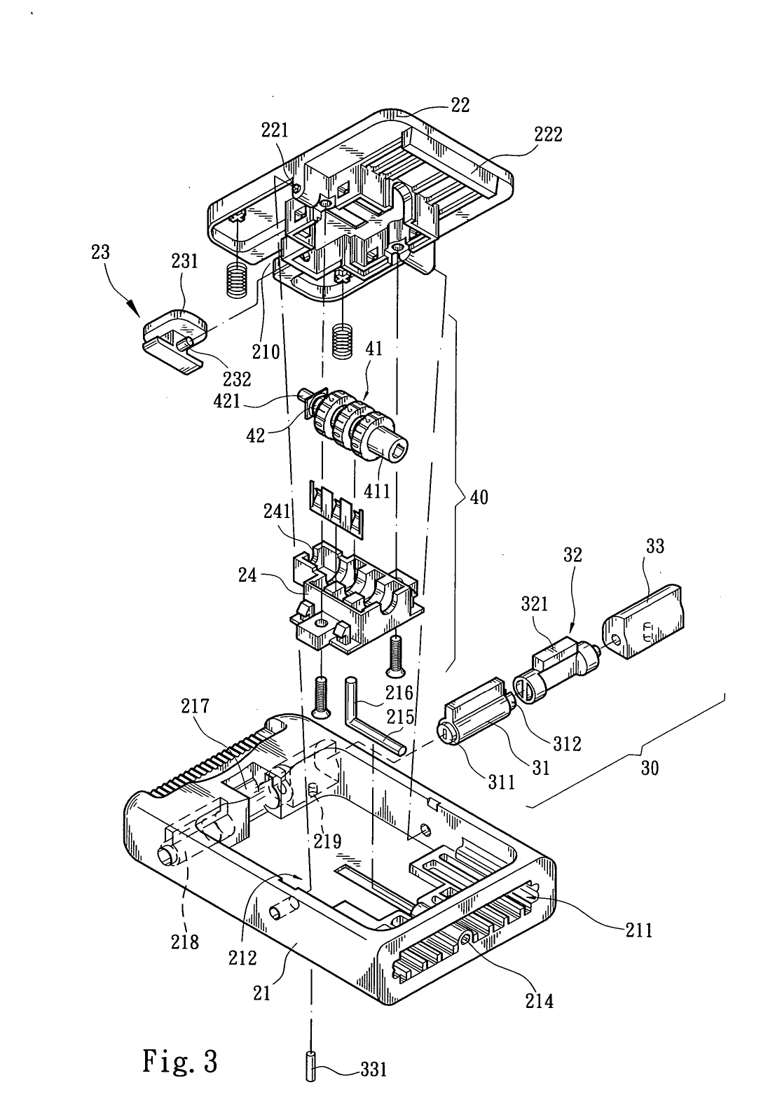

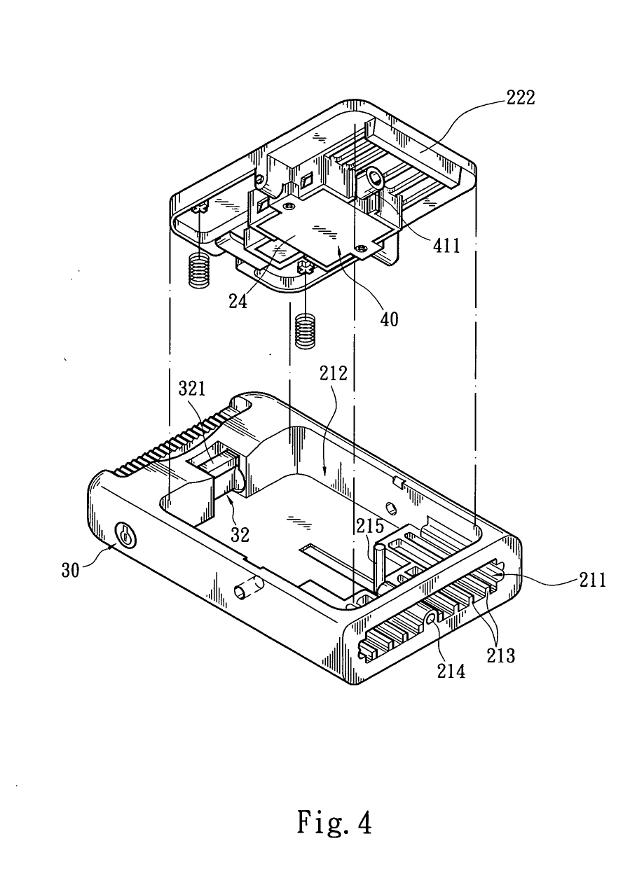

Referring to FIGS. 2 to 4, the female fastener 20 is composed of a seat body 21 and a teeterboard type latch plate 22 pivotally connected with the seat body 21. A key-unlocked unit 30 is disposed in a non-insertion end of the seat body 21. The other end of the seat body is formed with an insertion opening 211 corresponding to the insertion tongue 11 of the male fastener 10. In addition, the seat body 21 is recessed to form an operation room 212 communicating with the insertion opening 211. The latch plate 22 is mounted in the operation room 212. Stopper plates 213 are disposed in the operation room 212 near the insertion opening 211 without the entry of the insertion tongue 11. A number-changing rod receiving hole 214 is formed at the insertion opening 211 from outer side into the operation room 212. A number-changing push rod 215 is pivotally fitted in the receiving hole 214. An erect section 216 is formed at inner end of the push rod 215.

Two projecting shafts 221 are disposed on two sides of the latch plate 22 near a middle section thereof for pivotally connecting with two sides of the operation room 212 of the seat body 21. Accordingly, the latch plate 22 can be teetered back and forth within the operation room 212. A numeral unlocking unit 40 is disposed on inner face of the latch plate 22. One end of the latch plate 22 is formed with an engaging edge 222 corresponding to the inserted male fastener 10. When the insertion tongue 11 is inserted into the insertion opening 211, the engaging edge 222 is latched with the latch hook edge 111 of the insertion tongue 11. The other end of the latch plate is a press end 223 which can be pressed to lift the end with the engaging edge 222 so as to unlatch the latch hook edge 111. A movable member such as a push button 23 is disposed at the press end 223. The push button 23 is controlled by the numeral unlocking unit 40 to be displaceable or not.

The key-unlocked unit 30 is composed of a lock core seat 31, a support member 32 and a locating block 33. The lock core seat is fitted in a receptacle 218 of the seat body 21. An outer end of the lock core seat is formed with a key hole 311. An inner end of the lock core seat has a lock core 312 coupled with one end of the support member 32 for controlling the support member 32 to rotate. A support section 321 projects from the support member 32, whereby when the support member 32 is rotated, the support section 321 can enter a locking position to stop lower side of the push button 23 or enter an unlocking position to release the push button 23. The support member 32 is arranged in a dent 217 of the seat body 21. The other end of the support member is pivotally connected with the locating block 33. The locating block 33 is fixed in another receptacle 219 of the seat body 21 by a fixing member 331.

The numeral unlocking unit 40 is composed of a numeral wheel set 41 and a driving rod 42 driven and controlled by the numeral wheel set 41. The driving rod 42 is resiliently extensibly fitted in the numeral wheel set 41. A press end 421 of the driving rod 42 resiliently extends out from a hole 241 of the lock casing 24. The push button 23 of the latch plate 22 touches the press end 421 to control unlocking/locking thereof.

The press end 223 of the latch plate 22 is formed with a push slot 210 in which the push button 23 is slidably disposed. The push button 23 has a push plate 231. In natural state, a rear section of the push plate 231 can be resiliently pushed to engage on the support section 321 of the support member 32. The push button 23 has an abutting post 232 extending toward the lock casing 24. After assembled, the abutting post 232 right abuts against the press end 421 of the driving rod 42. In addition, after assembled, the erect section 216 of inner end of the number-changing push rod 215 right leans on a number-changing activating member 411 (such as numeral wheel bush of numeral lock) of the numeral unlocking unit 40.

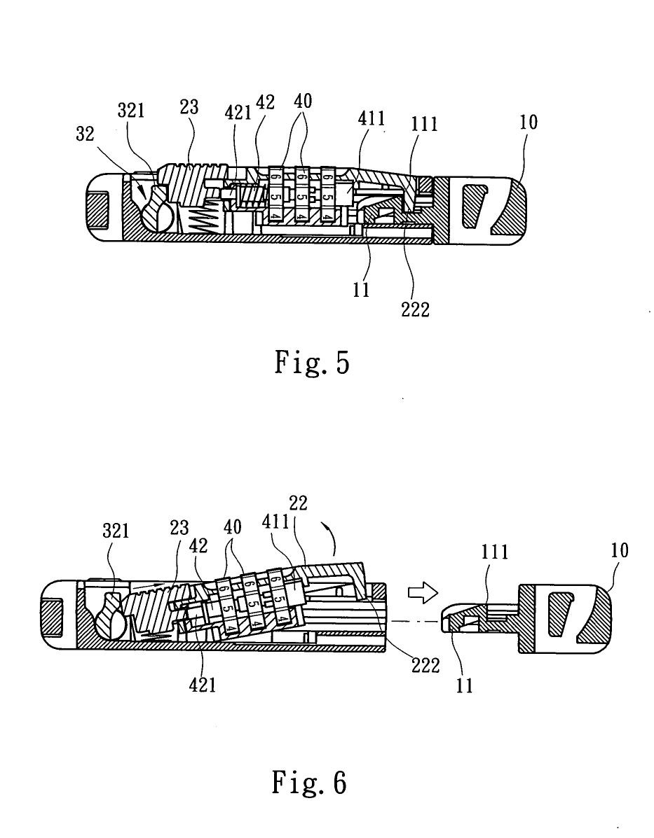

Referring to FIGS. 5 and 6, when the numeral unlocking unit 40 is in an unlocked state, the latch plate 22 can push the push button 23 to disengage from the support section 321. At this time, the press end 223 can be pressed to make the other end with the engaging edge 222 turn upward and unlatch from the latch hook edge 111 of the insertion tongue 11. The push button 23 can be directly inward pushed by a finger to disengage the rear section of the push plate 231 from the support section 321. Then the press end 223 of the latch plate 22 is pressed down to unlatch from the latch hook edge 111.

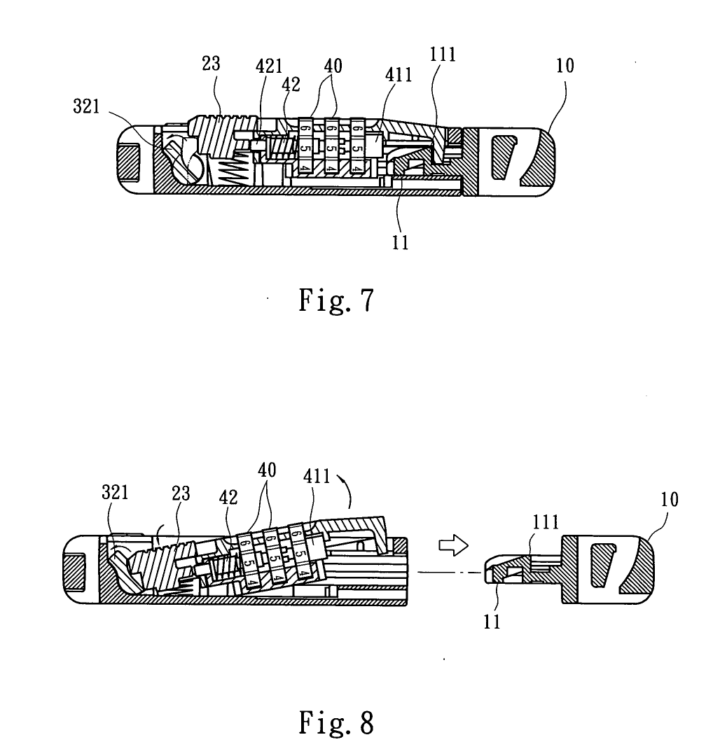

Referring to FIGS. 7 and 8, when a key is inserted into the key hole 311 of the key-unlocked unit 30 and turned to an unlocked state, the support section 321 of the support member 32 is turned outward and no more engaged with lower side of the push button 23. Therefore, there is a sufficient space for pressing down the press end 223 into the seat body 21. At this time, the other end with the engaging edge 222 is turned upward and unlatched from the latch hook edge 111 of the insertion tongue 11.

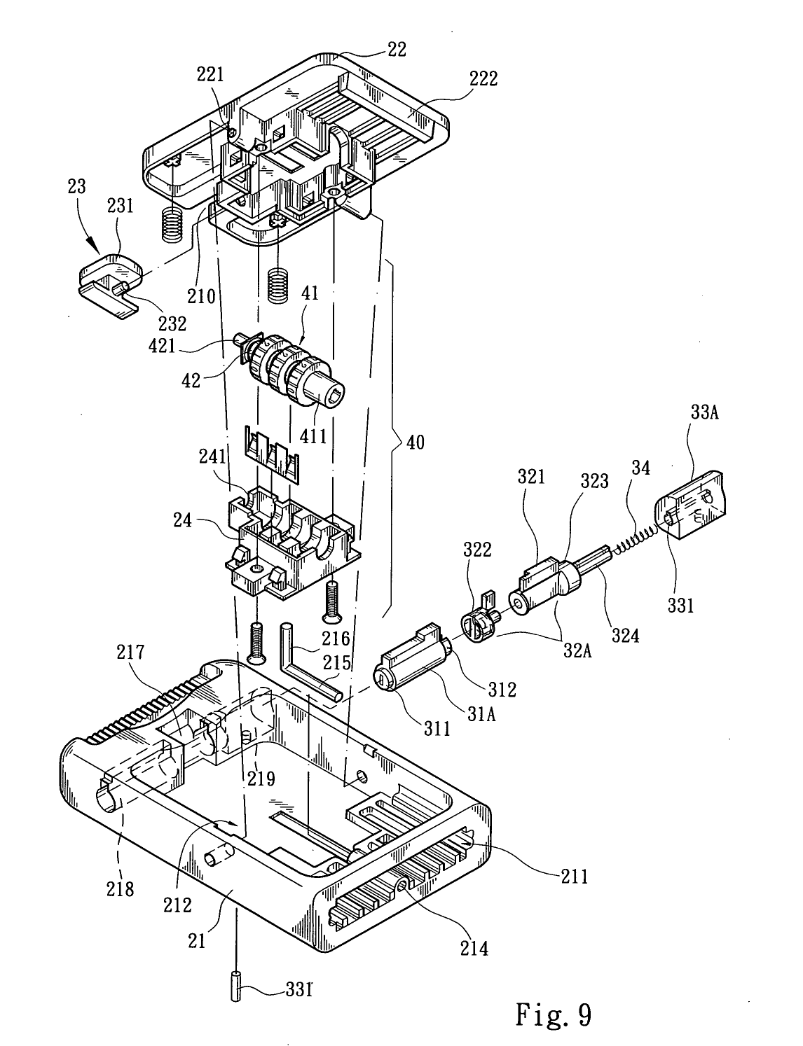

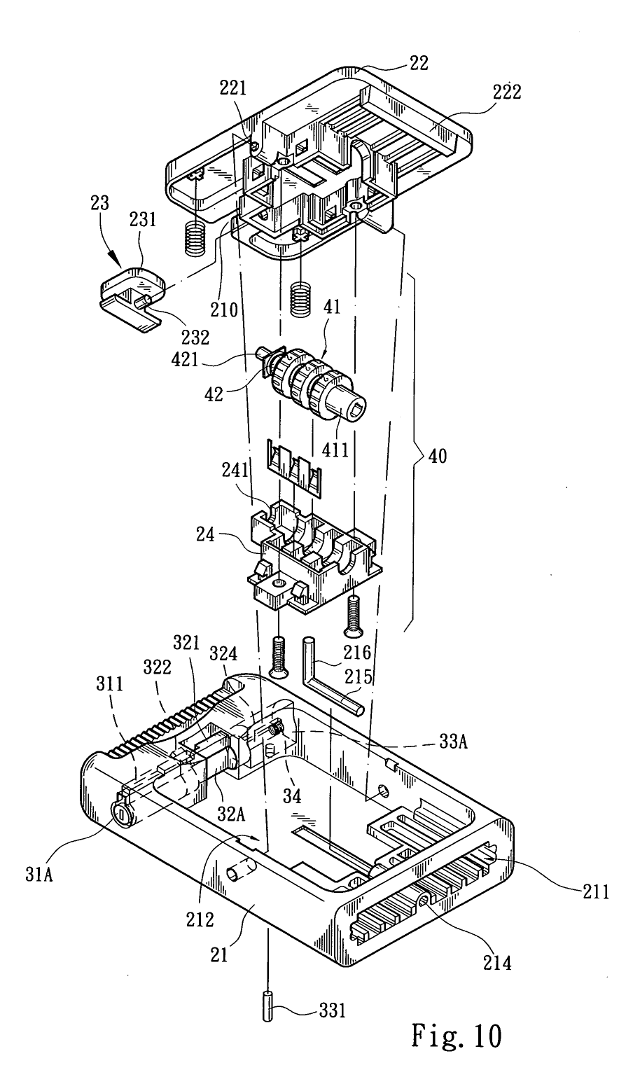

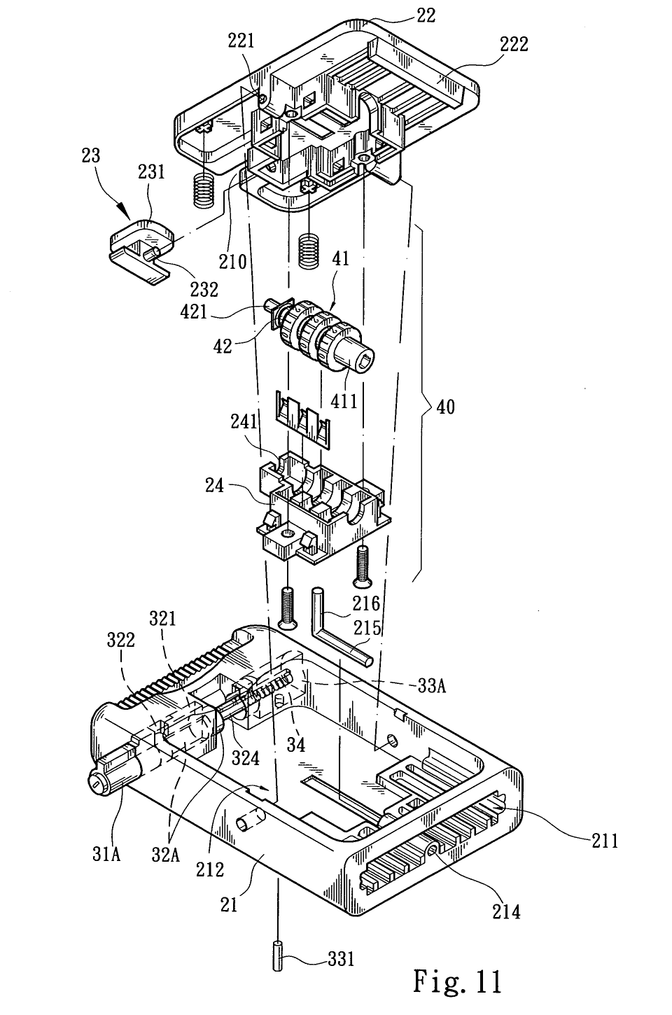

Referring to FIGS. 9 to 11, not only the key-unlocked unit 30 can be disengaged from the latch plate 22 by way of rotation, but also the lock core seat 31 can be axially drawn away from the engaged position. The key-unlocked unit can be alternatively composed of a lock core seat 31A, a support member 32A and a locating block 33A. The support member 32A is divided into a rotatable section 322 and a straight shift section 323 which is pivotally fitted with the rotatable section 322. One end of the straight shift section 323 is formed with a straight shift shaft 324 which is inserted in an extensible hole 331 of the locating block 33A. A resilient member 34 is disposed in the extensible hole 331 for resiliently pushing the straight shift shaft 324. In addition, the support member 32A has a support section 321 extending to the push button 23. One end of the rotatable section 322 is pivotally fitted in the straight shift section 321. The other end of the rotatable section 322 is coupled with inner end of the lock core 312 and rotatable therewith. The lock core seat 31A is mounted in the receptacle 218 of the seat body 21. The receptacle 218 is formed with a space allowing the lock core seat 31A to be axially outward drawn. Accordingly, in an unlocked state, the lock core seat 31A can be straightly shifted within the space. Reversely, in a locked state, the lock core seat is fixed in the space and cannot be straightly shifted. When the lock core seat is straightly shifted, the support member 32A can be straightly shifted to disengage from the push button 23.

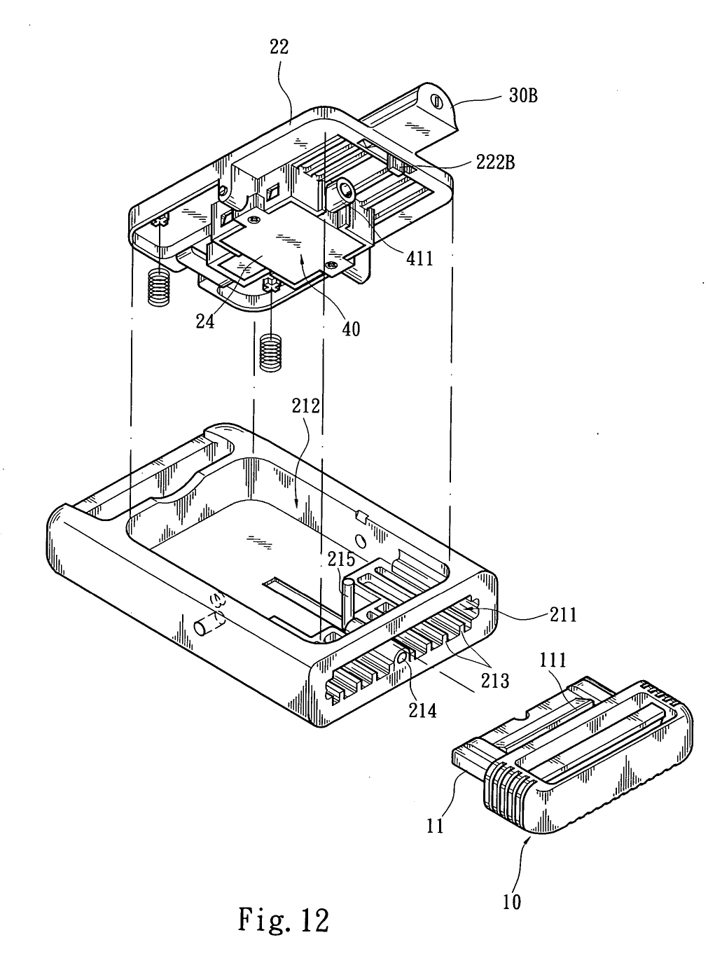

Referring to FIG. 12, the support member 32B is alternatively a fixed section of the seat body 21. The numeral unlocking unit 40B can control a movable member (such as a push button 23) to be movable or not. In a movable state, the latch plate 22 is free from the hindrance of the support member 32B and permitted to unlock and unlatch. The key-unlocked unit 30B can be mounted near the engaging edge 222B of the latch plate 22. The engaging edge 222B can be operated by the key-unlocked unit 30B to swing (as shown by the phantom line). Therefore, the latch hook edge 111 of the male fastener 10 can be released from the stop of the engaging edge 222B so that the male fastener 10 can be successfully extracted from the female fastener. This also achieves double unlocking effect.

According to the above arrangement, the present invention has double locking effects. In case a user forgets to bring an unlocking tool or forgets the unlocking number, the present invention provides another unlocking measure for the user. This also meets the regulation of U.S. customs. The present invention provides a convenient unlocking measure for a user, especially during travel.

The above embodiments are only used to illustrate the present invention, not intended to limit the scope thereof. Many modifications of the above embodiments can be made without departing from the spirit of the present invention.

1. A woven strap lock structure comprising a male fastener and a female fastener, wherein:
one end of the male fastener has an insertion tongue, a front end of the insertion tongue being formed with a latch hook edge;
the female fastener is composed of a seat body and a teeterboard type latch plate pivotally connected with the seat body, a support member being disposed on the seat body, one end of the seat body being formed with an insertion opening corresponding to the insertion tongue of the male fastener, the seat body being formed with an operation room communicating with the insertion opening, the latch plate being mounted in the operation room;
a section of the latch plate near the middle thereof is pivotally connected in the operation room of the seat body, one end of the latch plate being formed with an engaging edge corresponding to the insertion position of the male fastener, whereby when the insertion tongue is inserted into the insertion opening, the engaging edge is latched with the latch hook edge of the insertion tongue, a numeral unlocking unit being disposed on inner face of the latch plate, a movable member being disposed on the latch plate, the movable member being controlled by the numeral unlocking unit, whereby when the numeral unlocking unit is in an unlocked state, the movable member is free from the hindrance of the support member, permitting the latch plate to unlatch from the hook latch edge; and
a key-unlocked unit is disposed on the female fastener, wherein when the key-unlocked unit is an unlocked state, the latch plate is permitted to unlatch from the hook latch edge.

2. The woven strap lock structure as claimed in claim 1, wherein the key-unlocked unit is disposed at a non-insertion end of the seat body, one end of the latch plate near the non-insertion end being a press end which can be pressed into the seat body, whereby when the press end is pressed into the seat body, the end of the latch plate with the engaging edge is turned upward to unlatch from the male fastener, the support member being a part of the key-unlocked unit, whereby in a locked state, the support member abuts against lower side of the movable member to hinder the latch plate from being pressed down and unlatched, while in an unlocked state, the support member releases the movable member from the hindrance.

3. The woven strap lock structure as claimed in claim 2, wherein the support member has a support section projecting therefrom, whereby in the locked state, the support section abuts against lower side of the movable member, while in the unlocked state, the support section is disengaged from the movable member.

4. The woven strap lock structure as claimed in claim 3, wherein the key-unlocked unit is composed of a lock core seat, a support member and a locating block, an outer end of the lock core seat being formed with a key hole, an inner end of the lock core seat having a lock core coupled with one end of the support member for controlling the support member to rotate, the other end of the support member being pivotally connected with the locating block.

5. The woven strap lock structure as claimed in claim 1, wherein the numeral unlocking unit is composed of a numeral wheel set and a driving rod driven and controlled by the numeral wheel set, the driving rod being resiliently extensibly fitted in the numeral wheel set, a press end of the driving rod resiliently extending out from a hole of a lock casing, the movable member touching the press end, whereby the movable member is controlled to be movable or not in the unlocking/locking state.

6. The woven strap lock structure as claimed in claim 2, wherein the numeral unlocking unit is composed of a numeral wheel set and a driving rod driven and controlled by the numeral wheel set, the driving rod being resiliently extensibly fitted in the numeral wheel set, a press end of the driving rod resiliently extending out from a hole of a lock casing, the movable member touching the press end, whereby the movable member is controlled to be movable or not in the unlocking/locking state.

7. The woven strap lock structure as claimed in claim 3, wherein the numeral unlocking unit is composed of a numeral wheel set and a driving rod driven and controlled by the numeral wheel set, the driving rod being resiliently extensibly fitted in the numeral wheel set, a press end of the driving rod resiliently extending out from a hole of a lock casing, the movable member touching the press end, whereby the movable member is controlled to be movable or not in the unlocking/locking state.

8. The woven strap lock structure as claimed in claim 4, wherein the numeral unlocking unit is composed of a numeral wheel set and a driving rod driven and controlled by the numeral wheel set, the driving rod being resiliently extensibly fitted in the numeral wheel set, a press end of the driving rod resiliently extending out from a hole of a lock casing, the movable member touching the press end, whereby the movable member is controlled to be movable or not in the unlocking/locking state.

9. The woven strap lock structure as claimed in claim 3, wherein the movable member has a push plate, whereby in a natural state, one end of the push plate is engaged on the support section of the support member.

10. The woven strap lock structure as claimed in claim 4, wherein the movable member has a push plate, whereby in a natural state, one end of the push plate is engaged on the support section of the support member.

11. The woven strap lock structure as claimed in claim 5, wherein the movable member has an abutting post extending toward the press end of the driving rod for pushing the press end.

12. The woven strap lock structure as claimed in claim 6, wherein the movable member has an abutting post extending toward the press end of the driving rod for pushing the press end.

13. The woven strap lock structure as claimed in claim 7, wherein the movable member has an abutting post extending toward the press end of the driving rod for pushing the press end.

14. The woven strap lock structure as claimed in claim 8, wherein the movable member has an abutting post extending toward the press end of the driving rod for pushing the press end.

15. The woven strap lock structure as claimed in claim 1, wherein the key-unlocked unit is mounted in a receptacle of the seat body, the receptacle being preformed with a space, whereby in an unlocked state, the lock core seat can be axially straightly outward drawn within the space, when outward drawn, the support member being synchronously straightly shifted to disengage from the movable member, whereby the latch plate can be pressed down and unlatched.

16. The woven strap lock structure as claimed in claim 2, wherein the key-unlocked unit is mounted in a receptacle of the seat body, the receptacle being preformed with a space, whereby in an unlocked state, the lock core seat can be axially straightly outward drawn within the space, when outward drawn, the support member being synchronously straightly shifted to disengage from the movable member, whereby the latch plate can be pressed down and unlatched.

17. The woven strap lock structure as claimed in claim 1, wherein the key-unlocked unit is mounted near the engaging edge of the latch plate, the engaging edge being operable by the lock core of the key-unlocked unit, whereby in the unlocked state, the latch hook edge of the insertion tongue of the male fastener can be released from the stop of the engaging edge so that the male fastener can be freely extracted from the female fastener.
